(19) United States
(12) Patent Application Publication
(10) Pub. No.: US 2007/0217554 A1
(43) Pub. Date: Sep. 20, 2007

(54) Noise Canceling in Equalized Signals

(75) Inventor: Gunnar Wetzker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,553

(22) PCT Filed: Jun. 14, 2005
(86) PCT No.: PCT/IB05/51962

§ 371 Date: Dec. 13, 2006

(30) Foreign Application Priority Data
Jun. 24, 2004 (EP) 04102938.0

(51) Int. Cl. H04B 1/10

(52) U.S. Cl. 375/350

(57) ABSTRACT

A receiver (20) that is suitable to receive at least two, simultaneously transmitted signals uses a linear equalizer (18) for equalizing the received signals. Additionally such receiver has a signal quality estimator (36) to determine which of the equalized signals has the best signal to noise ratio. A noise estimator (31) derives a correlated noise signal (n₁, n₂) from equalized signal having the best signal to noise ratio. This correlated noise signal (n₁,n₂)is used to cancel the correlated noise with another of the equalized signals, so as to improve the signal to noise ratio of that signal.

The invention relates to a receiver arranged to receive at least two, simultaneously transmitted, signals and to a device comprising such receiver. Furthermore, the invention relates to a method for receiving at least a first and second simultaneously transmitted signal.

A receiver for receiving at least and a second simultaneously transmitted signal is known from the published US patent application 2003/0112880A1. The receiver comprises a channel processor for equalizing the received signal. The receiver is arranged to iteratively cancel the interference between the received signals and to improve transmission performance by reporting the channel state information back to the transmitter.

It is an object of the invention to provide a receiver for receiving at least two simultaneously transmitted signals that does not require a feedback of the channel state information. This is according to invention realized in that the receiver comprises:

a linear equalizer arranged to equalize the at least two received signals into at least two equalized signal;

a signal quality estimator arranged to determine a first of the at least two equalized signals that is having the better signal to noise ratio;

a noise estimator arranged to derive a correlated noise signal from the first of the at least two equalized signals; and

a noise canceller arranged to remove the correlated noise signal from a second of the at least two equalized signals so as to obtain an enhanced second of the at least two equalized signals that is having an improved signal to noise ratio.

The invention is based upon the insight that although use of a linear equalizer is attractive in terms of implementation complexity, it has as a major drawback that the signal to noise ratios of the at least two equalized signals are not the same due to the presence of noise which is added during the transmission of the at least two simultaneously transmitted signals. The invention is further based upon the insight that instead of the iterative interference canceling, a noise cancellation can be used because the noise components of the received signal streams become correlated after the equalization operation. Therefore, no feedback to the transmitter has to be provided. By deriving the estimate of the correlated noise signal from the equalized signal that is having a superior signal to noise ratio for estimating the correlated noise signal, it can be assured that the estimate of the correlated noise signal is the most reliable estimate possible.

In an embodiment of a receiver according to the invention, the noise canceller comprises a first subtracter for subtracting the correlated noise signal from the second of the at least two equalized signals. By subtracting the estimate of the correlated noise signal from the second of the at least two equalized signals, i.e., the equalized signal having the worst signal to noise ratio, the second of the at least two equalized signals can be enhanced. This means that the signal to noise ratio of this signal is improved.

In an embodiment of a receiver according to the invention is the noise estimator comprises:

a transmitted signal estimator, arranged to obtain an estimate of a first of the at least two simultaneously transmitted signals from the first of the at least two equalized signals;

a second subtracter arranged to subtract the first of the at least two equalized signals from the estimate of the first of the at least two simultaneously transmitted signals so as to obtain an intermediate estimate of the correlated noise signal; and

a signal weighter arranged to weight the intermediate estimate of the correlated noise signal with a first weighting factor so as to obtain the correlated noise signal.

The signal estimator has a repeater-like behavior, which basically regenerates the simultaneously transmitted signals by using the equalized signals. By subtracting the first of the at least two equalized signals from the estimated signal, an intermediate estimate of the correlated noise signal is obtained. By multiplying this intermediate noise estimate with a weighting factor, the correlated noise signal can be obtained. The weighting factor represents the level of correlation between the first and second equalized signal.

In another embodiment of the receiver according to the invention, the noise estimator comprises a first delay element arranged to delay the first of the at least two equalized signals with a first delay period before subtracting the first of the at least two equalized signals from the estimate of the first of the at least two simultaneously transmitted signals. It will be apparent to the skilled reader that a noise estimator will have a certain latency. By delaying the first of the at least two equalized signals it can be assured that this signal remains synchronized with the estimated signal.

In an embodiment of the receiver according to the invention, the noise canceller comprises a second delay element arranged to delay the second of at least two equalized signals with a second delay period prior to subtracting the estimate of the correlated noise signal. Through this it is possible to synchronize the noise canceller with the noise estimator.

In yet another embodiment of the receiver according to the invention, the noise estimator comprises a first buffer arranged to buffer the intermediate estimate of the correlated noise signal. Through this equalized signals, which have been coded block-wise, can be processed.

In another embodiment of the receiver according to the invention, the noise canceller comprises a second buffer arranged to buffer the second of the at least two equalized signals prior to subtracting the estimate from the correlated noise signal. This too is required in case the equalized signals have been coded block-wise.

In an embodiment of the receiver according to the invention, the signal estimator comprises a cascade of a signal decoder and a signal encoder. Therewith, the transmitted signal estimator obtains a repeater-like behavior.

In an embodiment of the receiver according to the invention, the signal decoder comprises a demapper, and the signal encoder comprises a mapper. This configuration is particularly suited for single carrier signals.

In yet another embodiment of the receiver according to the invention, the signal decoder comprises a cascade of a demapper and a channel decoder and the signal encoder comprises a cascade of a channel encoder and a mapper. This configuration could be used for channel-encoded signals, or for multicarrier signals in case the communication channels exhibit a short delay spread.

In an embodiment of the receiver according to the invention the receiver is arranged to repeatedly derive the correlated noise signal and to repeatedly remove the correlated noise signal from the second of the at least two equalized signals. Herewith, the second of the at least two equalized signals can remain optimized over longer periods of time.

In another embodiment of the receiver according to the invention the receiver comprises an amplitude compensator arranged to compensate amplitude fluctuations of the enhanced version of the second of the at least two equalized signals. Through this, amplitude fluctuations in the enhanced version of the second of the at least two equalized signals that arise because of the noise canceling process, can be compensated.

In another embodiment of the receiver according to the present invention the receiver further comprises an interference canceller that is arranged to cancel the interference between the at least two equalized signals. This may improve the performance of the receiver even further in case the at least two equalized signals interfere which each other.

These and other aspects of the invention will be further elucidated by means of the following drawings.

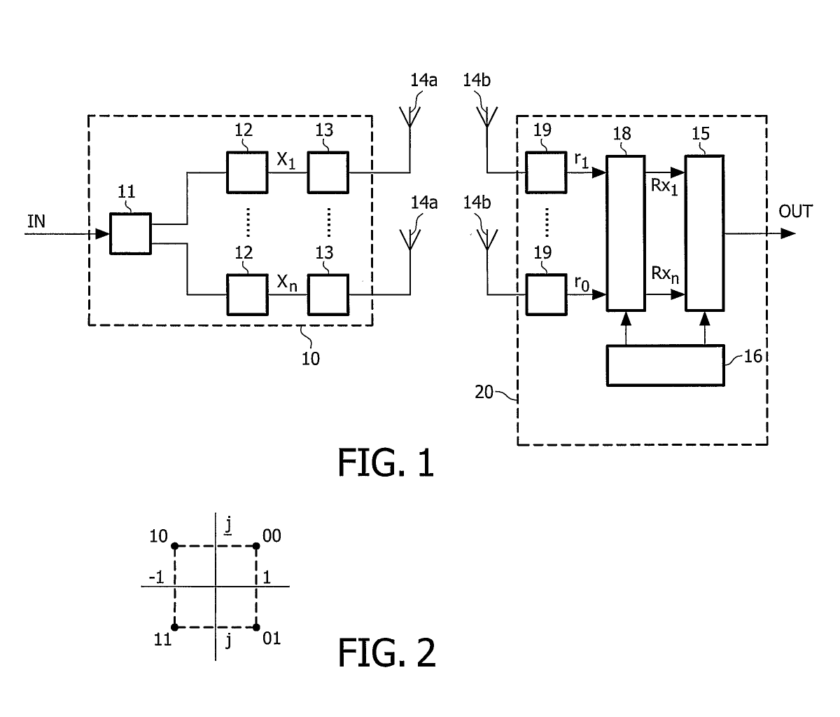

FIG. 1 shows a telecommunication system according to the present invention.

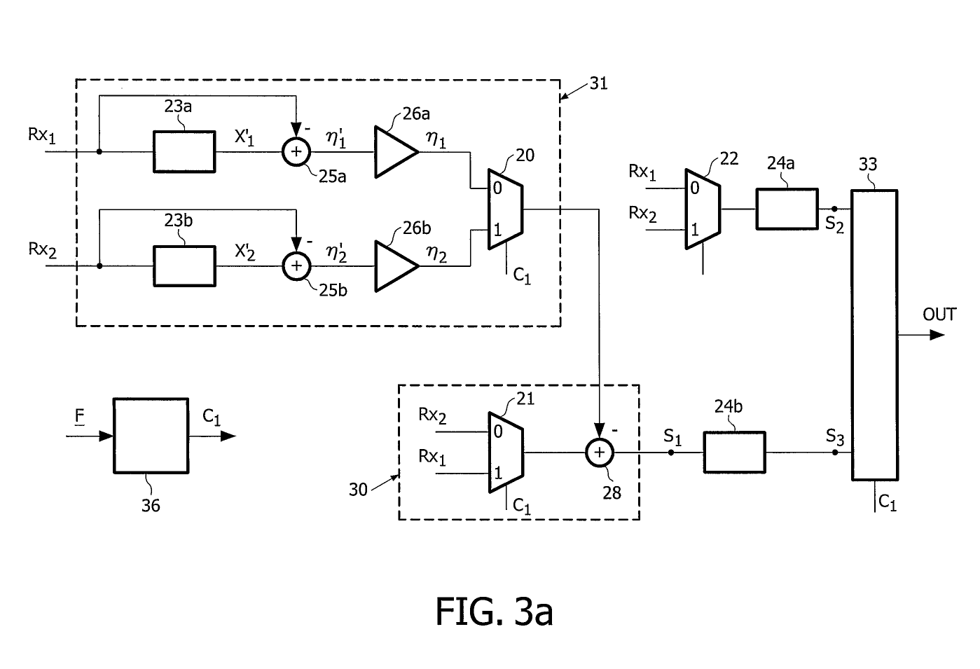

FIG. 2 shows a QPSK modulation constellation.

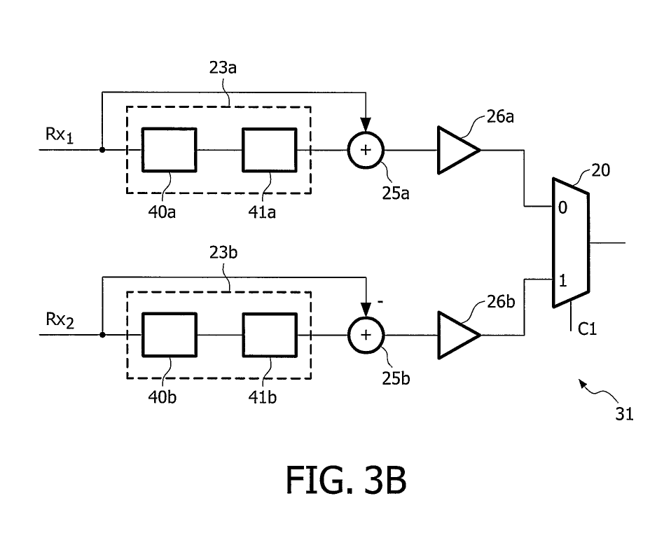

FIG. 3a shows a first embodiment of the invention.

FIG. 3b shows a more detailed embodiment of the noise estimator.

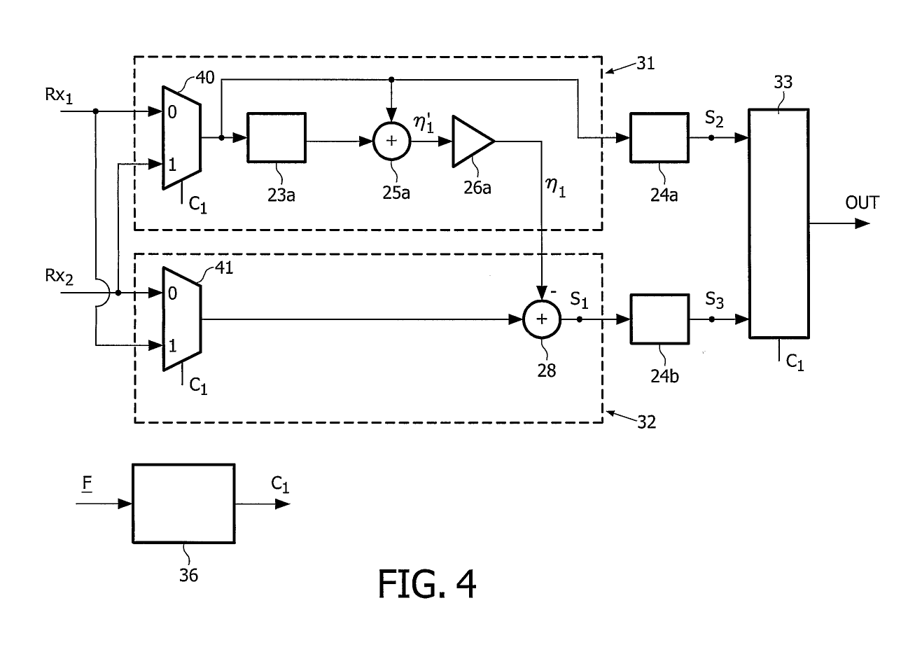

FIG. 4 shows an alternative embodiment of the invention.

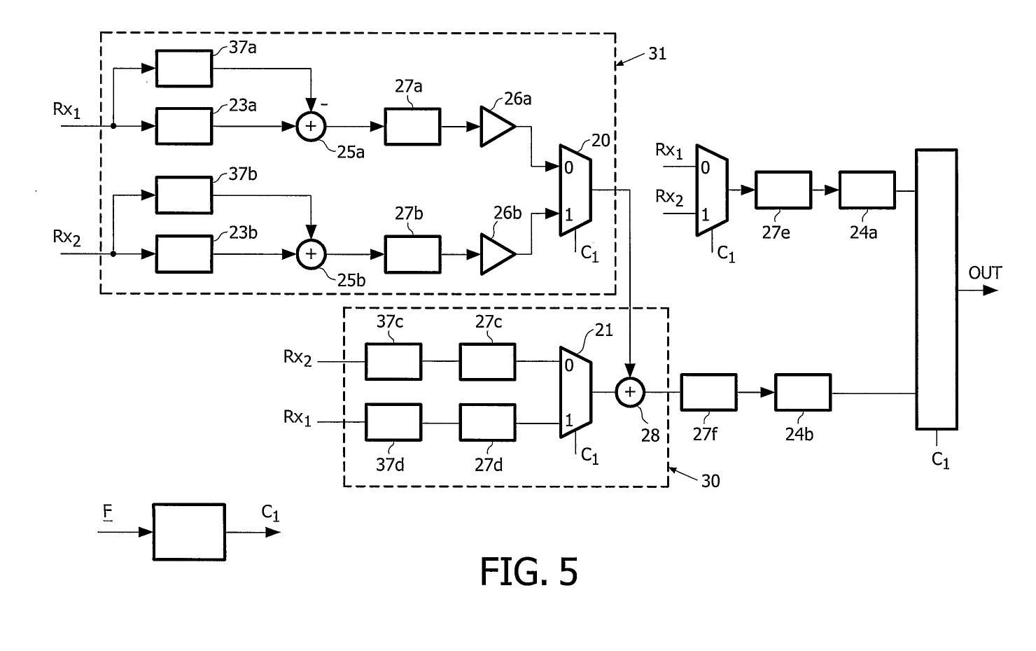

FIG. 5 shows another embodiment of the invention comprising delay elements and buffers for processing block-encoded signals.

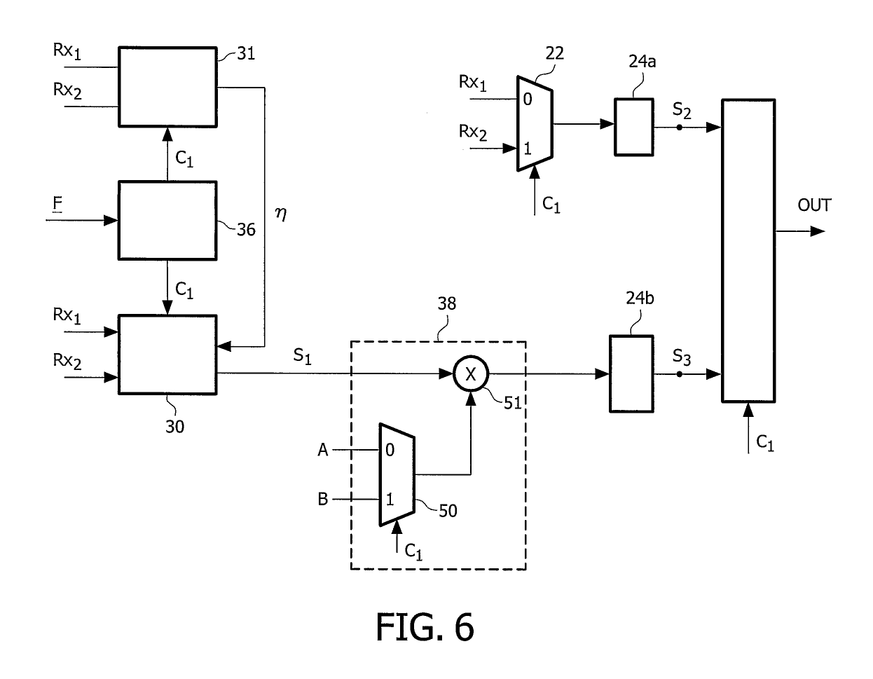

FIG. 6 shows yet another embodiment of the invention arranged to compensate amplitude fluctuations caused by noise canceling process.

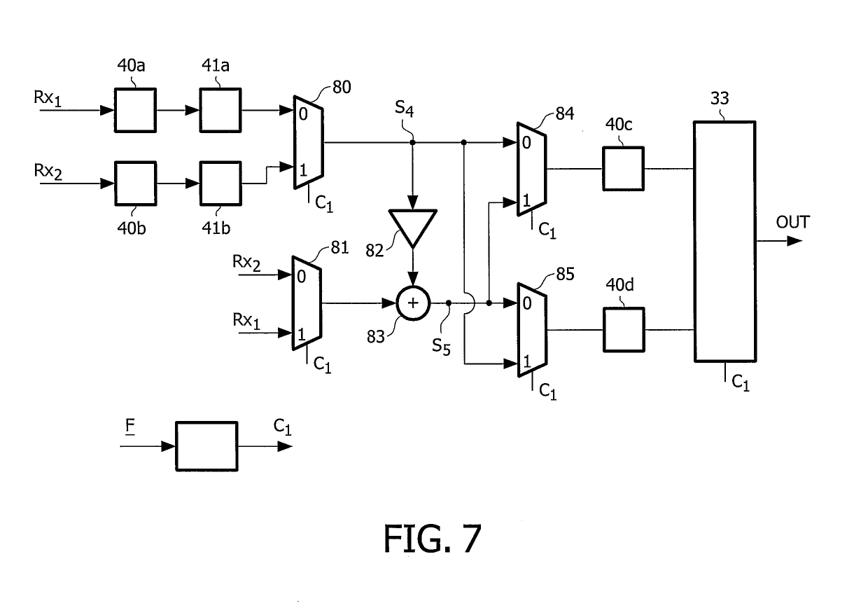

FIG. 7 show a possible configuration for canceling interference between the two equalized signals.

FIG. 1 shows a telecommunication system that comprises receiver 20 according to invention. At the transmitter 10, in input stream IN is de-multiplexed into several parallel streams. Each one of these streams is encoded by means of signal encoder 12. The encoded streams x=x₁ . . . xₙ are modulated by the RF front-ends 13 and subsequently transmitted to the receiver via antennas 14a. The streams can be encoded by mapping the streams onto symbols using so-called modulation constellations. An example of such modulation constellation is given in FIG. 2. According to FIG. 2, a QPSK modulation constellation, bit sequence 00 is mapped onto the symbol 1+j. Likewise, bit sequence 11 is mapped onto the symbol−1-j. At the receiving side 20 of FIG. 1, the transmitted signals are received by antennas 14b and processed by RF front-end 19 to yield the signals r=r₁ . . . rₙ. The relation between x=x₁ . . . xₙ and r=r₁. . . rₙ is given by:
r=H·x+n. (1)

In this relation, n denotes a noise signal which is added to the transmitted symbols x. Matrix H is the channel transfer matrix which represents the behavior of the transmission channel. The channel transfer matrix H is calculated by processing unit 17. There are various ways known in the art to calculate H e.g. by using known pilot signals or known preambles which are transmitted from transmitter to receiver. In this case H can easily be determined since H=r·x-⁻¹. At the receiver, the transmitted stream x is reconstructed by means of a linear equalizer 18 which is defined by its equalization matrix F. A zero forcing equalizer for example, has an equalization matrix F which equals F=H⁻¹. The equalizer coefficients fᵢⱼ of equalization matrix F are also calculated by processing unit 17. Once the equalization matrix is known, the equalizer can retrieve an estimate of the transmitted signals since by calculating F·r which yields:
F·r=F·H·x+F·n=Rx+z (2)

In this equation, z denotes the equalized noise vector which has affected the equalized signals Rx. The effect of the equalized noise vector z is that a correlated noise signal has been added to the equalized signals Rx. However, according to the present invention, a reduction of the noise vector z may be possible by taking into account that the added noise signal is a correlated noise signal.

FIG. 3, shows an implementation of module 15 according to the present invention for a 2×2 telecommunication system. In this case Rx=(Rx₁, Rx₂) has been obtained by equalizing signals r₁ and r₂. Element 36 is used to determine which of the equalized streams Rx₁, Rx₂ offers the best Signal to Noise Ratio (SNR). According to the invention, the SNR for the equalized i^{th} signal (i=1,2) can be calculated according to:

$${SNR}_{i} = A \cdot {P}_{T} / ( {N}_{0} {\sum }_{j = 1}^{Nrx} {\vert {f}_{i , j} \vert}^{2} ) \qquad ( 3 )$$

In this formula fᵢⱼ, denote the elements of the equalizations matrix F which is coupled through to an input of element 36. Furthermore, A is the channel attenuation, P_{T} denotes the transmitted power and N₀ denotes the noise power. Nᵣₓ indicates the number of receivers. For a 2×2 system, Nᵣₓ equals two. From this relation it can be observed that the equalized stream Rxᵢ that has the highest SNR, minimizes the relation:

$${min}_{i} {\sum }_{j = 1}^{Nrx} {\vert {f}_{i , j} \vert}^{2} \qquad ( 4 )$$

Control signal c₁, controls the operation of multiplexers 20, 21, 22 and also combiner 33. Control signal c₁ indicates which of the equalized signals Rx₁, Rx₂ has the highest signal to noise ratio. Signal c₁, is derived by element 36. As is shown in FIG. 3, the noise estimator 31 comprises two parallel branches for calculating the correlated noise signal η₁, η₂. The top branch is used to derive the correlated noise signal η₁ from Rx₁. The lower branch is used to derive the correlated noise signal η₂ from Rx₂. Each one of the branches comprises a transmitted signal estimator 23a, 23b for obtaining an estimate of the corresponding transmitted signal from the equalized signal Rx₁, Rx₂. An intermediate estimate of the correlated noise signal η′₁, η′₂ is obtained by subtracting the equalized signal Rx₁, Rx₂ from the corresponding estimate of the transmitted signal. After weighting the intermediate noise signal η′1, η′₂ with a weighting factor w₁ that represents the level of correlation between the equalized signals Rx₁, Rx₂, the correlated noise signal η₁, η₂ is obtained. The intermediate estimate of the correlated noise signal is weighted by multiplying the intermediate estimates η′₁, η′₂ with the weighting factor w₁. To this end, the noise estimator 31 comprises multiplier 26a and 26b.

If the signal Rx₁, has the highest signal to noise ratio, the weighting factor w₁, is determined according to the following formula:

$$w 1 = \frac{{\sum }_{j = 1}^{Ntx} {f}_{1 , j}^{*} {f}_{2 , j}}{{\sum }_{j = 1}^{Ntx} {\vert {f}_{1 , j} \vert}^{2}} \qquad ( 5 )$$

and otherwise (SNR₂>SNR₁) by

$$w 1 = \frac{{\sum }_{j = 1}^{Ntx} {f}_{2 , j}^{*} {f}_{1 , j}}{{\sum }_{j = 1}^{Ntx} {\vert {f}_{2 , j} \vert}^{2}} \qquad ( 6 )$$

As is shown in FIG. 3b, the transmitted signal estimator 23a, 23b, comprises a cascade of a signal decoder 40a, 40b and a signal encoder 41a, 41b. This provides the required repeater-like behavior to the transmitted signal estimator which yields a more reliable estimate of the at least two simultaneously transmitted signals x₁, x₂ than would be obtainable by only equalizing at least two simultaneously transmitted signals x₁, x₂. As can be seen from FIG. 3, multiplexer 20 is arranged to couple either η₁ or, η₂ through to noise canceller 30. To be more specific: only the estimate of the correlated noise signal η₁, η₂ that is derived from the equalized signal Rx₁, Rx₂ that has the superior signal to noise ratio is coupled through to the noise canceller 31. If, for example, Rx₁ possesses the superior signal to noise ratio, η₁ will be coupled through to the noise canceller 30 whilst otherwise η₂ will be coupled through. This way it can be assured that always the most reliable estimate of the correlated noise signal η₁, η₂ is used for canceling the correlated noise signal. Noise canceller 30 comprises a subtracter 28 for subtracting the estimate of the correlated noise signal η₁, η₂ from the equalized signal Rx₁, Rx₂ having the lowest signal to noise ratio. Likewise, this signal is selected by means of multiplexer 21, which again, is controlled by unit 36. By subtracting the estimate of the correlated noise signal η₁, η₂ from the equalized signal Rx₁, Rx₂ having the lowest signal to noise ratio, the enhanced signal si is obtained. Finally, the signal Rx₁, Rx₂ having the highest signal to noise ratio and the enhanced signal s₁ are decoded by the signal decoders 24a and 24b and combined (multiplexed) by means of combiner 33 into the single output stream OUT. It will be apparent that the person skilled in the art can easily derive other embodiments providing the same functionality. An example is provided by means of FIG. 4 wherein the same basic elements can be recognized i.e. noise estimator 31, noise canceller 32 and combiner 33. The implementation of the noise estimator 31 is somewhat simpler because the equalized signal Rx₁, Rx₂ with the superior signal to noise ratio is selected beforehand. This way the lower branch of the noise estimator 31 in FIGS. 3 can be omitted. The implementation of the decoder's 40a, 40b, 24a, 24b and encoder 41a, 41b depends on the type of signals transmitted. For single carrier signals, the decoder 40a, 40b, 24a, 24b may comprise a single demapper whereas the encoders 41a, 41b may comprise a mapper. In case of channel coded signals, the decoders 40a, 40b, 24a, 24b may comprise a cascade of a demapper and a channel decoder whereas the encoder 41a, 41b comprises a channel coder and a mapper. Channel coding involves the well-known operations of encoding (such as block encoding or convolutional encoding) followed by interleaving and puncturing. Consequently, channel decoding involves the operations de-interleaving, de-puncturing and de-coding. It is also possible to use the latter configuration for the decoding of multicarrier signals. However, in this case, the communication channels between transmitter and receiver should exhibit a short time delay spread. Account has to be given to the fact that the criterion for selecting the equalized signal having the highest Signal to Noise Ratio changes for multicarrier signals because with multicarrier signals the SNR per carrier has to be considered. For multicarrier signals, the capacity of signal xi on carrier j is given by:
Cᵢⱼ=log 2(1+SNRᵢⱼ) (7)
Therefore, the total capacity of signal xᵢ is given by:
C_{i=Σ}ⱼ₌₁^{Nc}Cᵢⱼ=Σⱼ₌₁^{Nc} log 2(1+SNRᵢⱼ)≧log 2(1+Πⱼ₌₁^{Nc}SNRᵢⱼ) (8)

Where Nc is the number of carriers. Since all Signal to Noise Ratios are per definition positive, the new selection criterion for a two stream multicarrier signal is given by:

if Πⱼ₌₁^{Nc}SNR₁ⱼ>Πⱼ₌₁^{Nc}SNR₂j Use Rx₁ for the calculation of the estimate of the correlated noise signal else use Rx₂. By doing so, it is guaranteed that the average detection/demodulation of the selected equalized signal Rx₁ Rx₂ is more reliable than on the other one. In the embodiments as shown in FIGS. 3, 3a and 4, individual coding of each of the transmitted streams x₁, x2 (see FIG. 1) is preferred over joint coding.

In case of increasingly frequency selective communication channels, the embodiment shown in FIG. 5 is preferred. In this case, it is decided on a per sub-carrier basis which of estimates of the correlated noise signal η₁, η₂ should be used for canceling the noise signal. The calculation of the SNR per stream and per sub-carrier could be done according to equation (3). In case the equalized signals have been block-wise encoded, buffering of the signals is required for buffering one complete block of symbols. That is why buffers 27a, 27b, 27c, 27d, 27e have been added. If however continuous decoding is possible, then only decoding delay has to be taken into account. In this case the buffers could be omitted. An example this decoding delay is the latency of the signal estimator 23. To compensate for the delays, delay elements 37a, 37b, 37c, 37d have been added. As matter of fact, these delay elements 37a, 37b, 37c, 37d could also be used in all the previous embodiments as well.

Depending on the type of equalizer used, it may be possible that the noise canceling has an influence on the signal which noise is being cancelled. This can be illustrated by means of the following example based on the use of Minimum Mean Squared Equalizer (MMSE). The equalizing matrix F of this type of equalizer can be expressed as:
F=(N_{0·}I+H^{H}H)⁻¹H^{H} (9)

In this case, N₀ represents the noise variance of one of the received signals x₁, x₂ (assuming equal noise variances in signals x₁, x₂), the matrix R=F·H (see formula 2) is not a diagonal matrix. This means that, for example in the case of a 2×2 system, the elements r₁₂ and r₂₁ of R are not equal to zero. Consequently, canceling of the noise might have a deteriorating influence on the signal component of the stream which noise is cancelled. It can easily be proven that after noise cancellation, the signal component amplitude is determined by the factor r₂₂−c·r₁₂ or by r₁₁−c·r₂₁. It will be apparent to the skilled reader that, in this case the noise cancellation operation will partially cancel the signal energy, which is obviously unwanted. A noise cancellation operation is then only advantageous if more noise than signal is cancelled. The amount of noise and signal canceling is fully determined by the channel estimates and the equalizer settings. It is however, possible to compensate for these amplitude changes since they are known. This is illustrated in more detail in FIG. 6 wherein an additional multiplexer 50 and multiplier 51 have been added. The gist of the invention is the enhanced signal is either multiplied by 1/(r₁₁−c·r₂₁) (A) if Rx₁ is the signal with the highest SNR or by 1/(r₂₂−c·r₁₂) (B) for all other cases. It will be apparent to the skilled person that this way the amplitude changes can easily be corrected.

In addition to compensating amplitude changes in the signal streams in case matrix R is not diagonal, it is possible to use an additional interference canceling prior to noise canceling In this case not only the noise of the two streams is correlated but additionally each one of the equalized signals leaks into the other one. It is possible to use a similar structure as for canceling the correlated noise to cancel out the leakage of these signal components. However, instead of estimating the noise, only the signal component is estimated, weighted and subtracted from the other stream. The decision, which stream to use for the first cancellation is again based on the signal-to-noise ratio. This kind of interference canceling is a well-known technique (e.g. BLAST) and can be used either prior or after the noise cancellation. If used before noise cancellation the above mentioned amplitude correction can be avoided. An example of such interference canceller is shown in FIG. 7. Signal decoder's 40a, 40b, 40c and 40 comprise a cascade of a demapper and a channel decoder. Signal encoder's 41a and 41b comprise a cascade of a channel encoder and a mapper. Which of the two estimated signals is passed through to multiplier 82, depends on the signal to noise ratios of the equalized signals Rx₁, Rx₂. Assuming that Rx₁ has the superior signal to noise ratio, it will be the signal estimated from Rx₁ that is coupled through to multiplier 82. Multiplier 82 is arranged to multiply its input signal with a weighting factor. Assuming that Rx₁ has the superior signal to noise ratio, the weighting factor equals r₂₁ otherwise the weighting factor equals r₁₂. Finally, the weighted signal is subtracted from the equalized signal having Rx₁, Rx₂ the lowest Signal to Noise ratio. Finally, multiplexers 84 and 85 route the signals S₄ and S₅ through to demapper 40 and channel decoders 41, to obtain estimates of signals x₁ and x₂ which are combined in combiner 33, to combine both streams into one data stream OUT.

It should be noted that the above-mentioned embodiments illustrate rather than limit the invention, and that those skilled in the art will be able to design many alternative embodiments without departing from the scope of the appended claims. All signal processing shown in the above embodiments can be carried in the analogue domain and the digital domain. The invention is not only applicable for a 2×2 system, but may also be used for a M×N system. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Receiver (20) arranged to receive at least two, simultaneously transmitted, signals comprising:
a linear equalizer (18) arranged to equalize the at least two received signals into at least two equalized signal (Rx₁, Rx₂);
a signal quality estimator (36) arranged to determine a first of the at least two equalized signals (Rx₁, Rx₂) that is having the better signal to noise ratio;
a noise estimator (31) arranged to derive a correlated noise signal (η₁, η₂) from the first of the at least two equalized signals (Rx₁, Rx₂); and
a noise canceller (30) arranged to remove the correlated noise signal (η₁, η₂) from a second of the at least two equalized signals (Rx₁, Rx₂) so as to obtain an enhanced second (s₁) of the at least two equalized signals (Rx₁, Rx₂) that is having an improved signal to noise ratio.

2. Receiver (20) according to claim 1, wherein the noise canceller (31) comprises a first subtracter (28) for subtracting the correlated noise signal (η₁, η₂) from the second of the at least two equalized signals.

3. Receiver (20) according to claim 1, wherein the noise estimator (31) comprises:
a transmitted signal estimator (23a, 23b), arranged to obtain an estimate of a first of the at least two simultaneously transmitted signals (x₁, x₂) from the first of the at least two equalized signals (Rx₁, Rx₂);
a second subtracter (25a, 25b) arranged to subtract the first of the at least two equalized signals (Rx₁, Rx₂) from the estimate of the first of the at least two simultaneously transmitted signals (x₁, x₂) so as to obtain an intermediate estimate of the correlated noise signal (η′₁, η′₂); and
a signal weighter (26a, 26b) arranged to weight the intermediate estimate of the correlated noise signal (η′₁, η′₂) with a first weighting factor (w₁) so as to obtain the correlated noise signal (η₁, η₂).

4. Receiver according to claim 3, wherein the noise estimator (31) comprises a first delay element (37a, 37b) arranged to delay the first of the at least two equalized signals (Rx₁, Rx₂) with a first delay period before subtracting the first of the at least two equalized signals (Rx₁, Rx₂) from the estimate of the first of the at least two simultaneously transmitted signals (x₁, x₂).

5. Receiver according to claim 3, wherein the noise canceller (30) comprises a second delay element (37c, 37d) arranged to delay the second of at least two equalized signals (Rx₁, Rx₂) with a second delay period prior to subtracting the estimate of the correlated noise signal (η₁, η₂).

6. Receiver according to claim 3, wherein the noise estimator (31) comprises a first buffer (27a, 27b) arranged to buffer the intermediate estimate of the correlated noise signal (η′₁, η′₂).

7. Receiver according to claim 3, wherein the noise canceller comprises a second buffer (27c, 27d) arranged to buffer the second of the at least two equalized signals (Rx₁, Rx₂) prior to subtracting the estimate from the correlated noise signal (η₁, η₂).

8. Receiver according to claim 3, wherein the transmitted signal estimator (23a, 23b) comprises a cascade of a signal decoder and a signal encoder.

9. Receiver according claim 8, wherein the signal decoder comprises a demapper, and the signal encoder comprises a mapper.

10. Receiver according to claim 8, wherein the signal decoder comprises a cascade of a demapper and a channel decoder and the signal encoder comprises a cascade of a channel encoder and a mapper.

11. Receiver (20) according to claim 1, wherein the receiver (20) is arranged to repeatedly derive the correlated noise signal (η₁, η₂) from the at least two equalized signals (Rx₁, Rx₂).

12. Receiver (20) according to claim 1, wherein the receiver comprises an amplitude compensator (38) arranged to compensate amplitude fluctuations of the enhanced version (s₁) of the second of the at least two equalized signals (Rx₁, Rx₂).

13. Receiver according to claim 12, wherein the amplitude compensator (38) comprises a multiplier (51) for multiplying the enhanced version (s₁) of the second of the at least two equalized signals with a second weighting factor (w₂).

14. Receiver according to claim 13, wherein the compensation factor (w₁) is determined by the signal to noise ratios of the at least two equalized signals (Rx₁, Rx₂).

15. Receiver according to claim 1, wherein the receiver further comprises an interference canceller that is arranged to cancel the interference between the at least two equalized signals (Rx₁, Rx₂).

16. Device comprising a receiver according to claim 1.

17. Method for receiving at least a first and a second simultaneously transmitted signal, the method comprising the steps of:
linearly equalizing the at least two received signals into at least two equalized signal (Rx₁, Rx₂);
determining a first of the at least two received signals (Rx₁, Rx₂) that is having the better signal to noise ratio;
estimating a correlated noise signal (η₁, ƒ₂) from the first of the at least two equalized signals (Rx₁, Rx₂); and
canceling the correlated noise signal from a second of the at least two equalized signals (Rx₁, Rx₂) by subtracting the estimate of the correlated noise signal (η₁, η₂) from the second of the at least two equalized signals (Rx₁, Rx₂) so as to obtain an enhanced second (s₁) of the at least two equalized signals (Rx₁, Rx₂) that is having an improved signal to noise ratio.
